(19) United States
(12) Patent Application Publication
(10) Pub. No.: US 2009/0086278 A1
(43) Pub. Date: Apr. 2, 2009

(54) ELECTRONIC FACSIMILE DELIVERY SYSTEMS AND METHODS

(75) Inventors: Vlad Vendrow, Redwood City, CA (US); Bruce Young, San Jose, CA (US)

Correspondence Address: Kokka & Backus, PC, Suite 103, 200 Page Mill Road, Palo Alto, CA, 94306, US

(73) Assignee: RingCentral, Inc., Redwood City, CA (US)

(21) Appl. No.: 12/234,598

(22) Filed: Sep. 19, 2008

Related U.S. Application Data
(60) Provisional application No. 60/995,787, filed on Sep. 27, 2007.

(51) Int. Cl. H04N 1/00

(52) U.S. Cl. 358/402

(57) ABSTRACT

Embodiments of the invention relate generally to computing devices and systems, as well as software, computer programs, applications, and user interfaces, and more particularly, to delivering electronic messages, including electronic facsimiles, in a communication network including packetized and/or synchronous communications, so that the electronic messages are delivered according to their relative priorities. The relative priorities can be set according to at least one attribute of the electronic messages, and these attributes can be provided by at least one of a sender of an electronic message, an intended recipient of an electronic message, and a messaging system The information determining a priority of a message also can include information about priorities of other messages, information regarding whether a message has been scheduled for delivery, information as to whether a message should be cancelled, and information concerning an optimal transmitting device.

### CROSS-REFERENCE TO RELATED APPLICATIONS

This application is a U.S. Provisional patent application that claims the benefit of U.S. Provisional Patent Application No. 60/995,787, filed Sep. 27, 2007 with Attorney Docket No. RIN-002P, and entitled “Electronic Facsimile Delivery Systems and Methods,” which is herein incorporated by reference for all purposes.

### FIELD OF THE INVENTION

Embodiments of the invention relate generally to computing devices and systems, as well as software, computer programs, applications, and user interfaces, and more particularly to delivering electronic fax messages in a communication network for packetized and/or synchronous communications.

### BACKGROUND OF THE INVENTION

While traditional techniques for delivering electronic faxes are functional, there are certain drawbacks to these techniques. Congestion of resources results from the inability to schedule delivery of electronic facsimiles and other electronic messages. Messages having a relatively high priority may arrive in queue for transmission without any regard to their importance, which can have adverse consequences for one or more of the parties in communication.

It would be desrable to provide computing devices and systems, as well as software, computer programs, applications, and user interfaces that minimize one or more of the drawbacks associated with the conventional techniques for generating and/or delivering electronic faxes. For example, it would be desirable to be able to assign a priority to an electronic message, such as an electronic facsimile, based on one or more attributes associated with each electronic message to be transmitted, so that each electronic message is transmitted in timely fashion to its destination.

### BRIEF DESCRIPTION OF THE FIGURES

The invention and its various embodiments are more fully appreciated in connection with the following detailed description taken in conjunction with the accompanying drawings, in which:

FIG. 1A is a diagram of a messaging system configured to deliver electronic messages, such as electronic facsimiles, according to at least one embodiment of the invention;

FIG. 1B is a diagram of a messaging system configured to prioritize electronic messages, such as electronic facsimiles, and to deliver such messages based on a priority, according to at least one embodiment of the invention;

FIG. 2 is a diagram showing an example of a process by which the prioritizer of FIG. 1B determines a priority for electronic facsimiles, according to at least one embodiment of the invention;

FIG. 3 is a diagram of a messaging system including pre-processing logic for facilitating delivery of electronic messages, such as electronic facsimiles, according to at least one embodiment of the invention;

FIG. 4 is a flow diagram showing an example of a method for pre-processing electronic facsimiles, according to one embodiment of the invention;

FIG. 5 is a diagram showing an example of a messaging system, according to at least one embodiment of the invention;

FIG. 6 is a diagram showing an example of a panel configured to schedule delivery of an electronic message via a messaging system, according to at least one embodiment of the invention;

FIGS. 7A and 7B illustrate examples of panel presentation applications for electronic message prioritization and delivery, according to various embodiments of the invention;

FIG. 8 illustrates an exemplary computer system suitable for electronic message prioritization and delivery, according to various embodiment of the invention; and

FIG. 9 illustrates an example of an interface for facilitating electronic message prioritization and delivery, according to various embodiment of the invention.

Like reference numerals refer to corresponding parts throughout the several views of the drawings. Note that most of the reference numerals include one or two left-most digits that generally identify the figure that first introduces that reference number.

### DETAILED DESCRIPTION

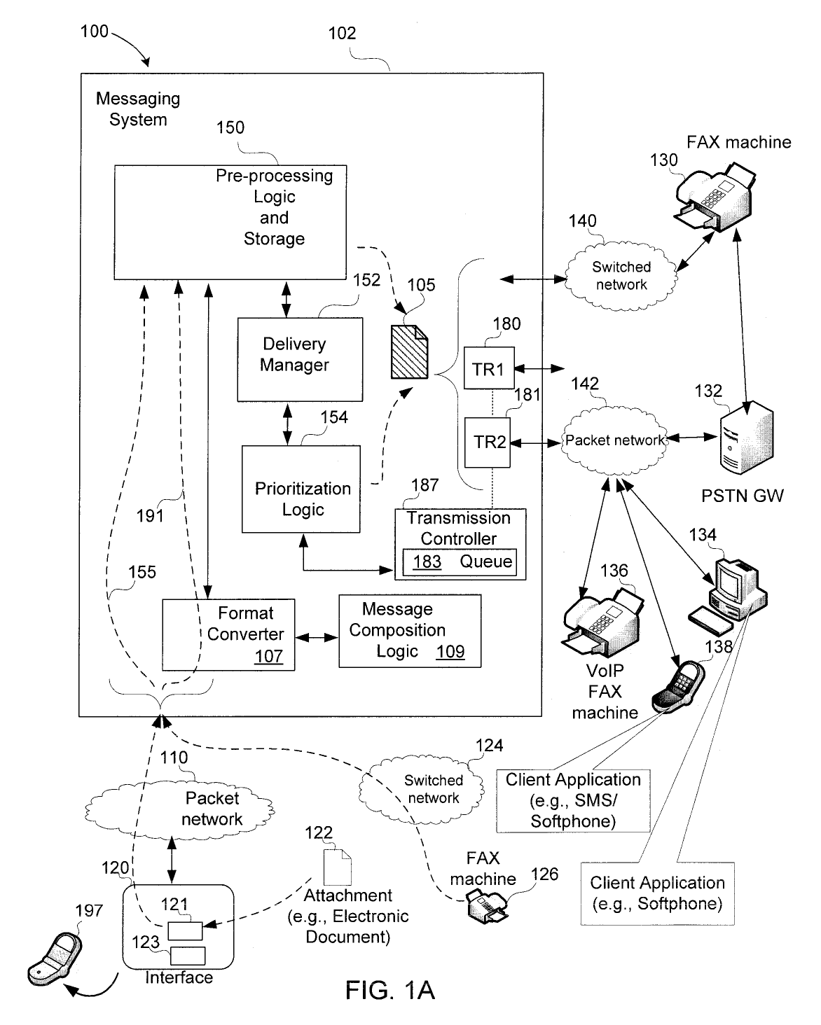

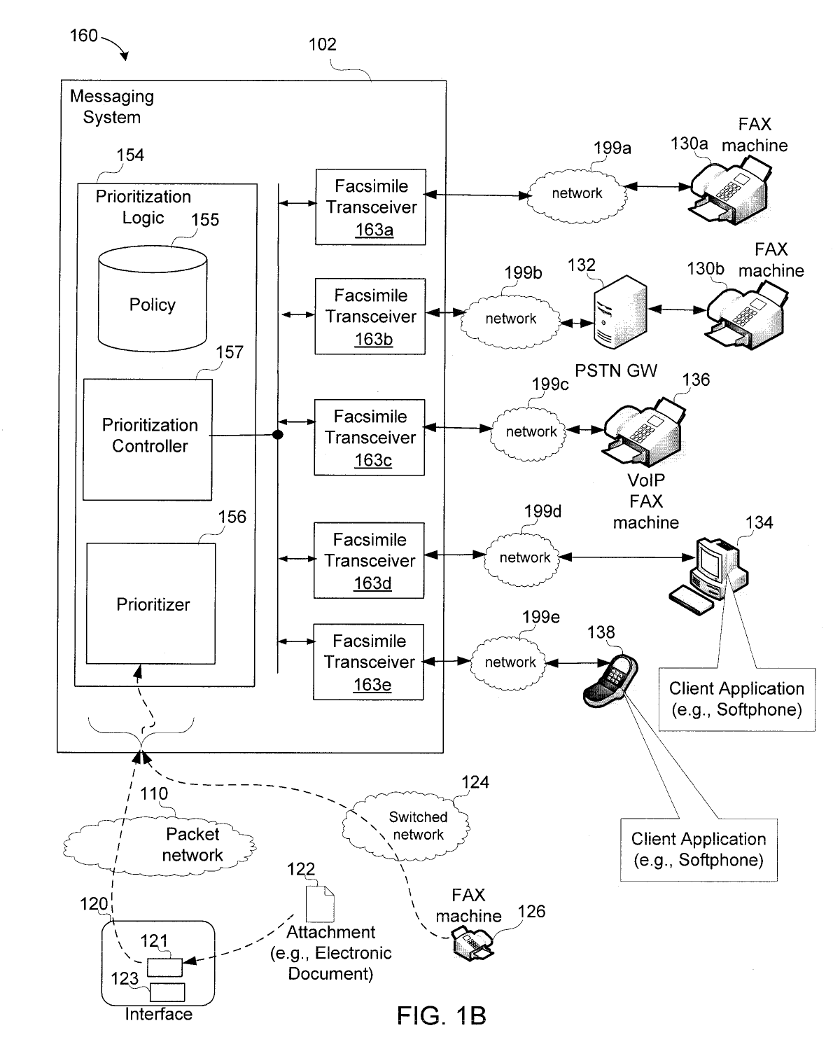

FIG. 1A is a diagram 100 of a messaging system configured to deliver electronic messages, such as electronic facsimiles, according to at least one embodiment of the invention. FIG. 1A shows an interface 120 coupled via, for example, a packet network 110 to a messaging system 102 for delivering an electronic facsimile 105 to a switched network 140, to another packet network 142, or to any type of other communications network (not shown). Messaging system 102 can also be configured to facilitate the delivery of electronic facsimiles by receiving data (e.g., data representing electronic facsimile components) over a switched network 124, whereby the data can originate from a fax machine 126, which can be a T.30 fax endpoint. In various embodiments, messaging system 102 can be configured to deliver (e.g., either sending or receiving) an electronic facsimile between any two or more communication devices. Examples of such communication devices include analog group 3 (“T.30”) fax endpoints (e.g., fax machine 130), T.38 PSTN fax gateways (e.g., PSTN GW 132), a computing device 134 including either an email box in an email client application or in a fax delivery application (e.g., to implement a softphone), and any other suitable type of communication device, such as a voice-over-internet-protocol (“VoIP”) fax machine 136 or a wireless phone, which can implement Short Message Service (“SMS”) or any other types of text messaging. As such, message system 102 (FIG. 1A) can be referred to as a “unified messaging system.”

In the context of delivering an electronic facsimile 105, interface 120 can be configured to implement a message input field 121 to attach an electronic document 122 as part of electronic facsimile 105. Message input field 121 can be configured to use electronic documents, regardless of the file format of electronic document 122, by using interface 120. Interface 120 can be configured to create and send faxes between any repositories and/or fax endpoints over packetized and/or synchronous communication networks. In one example, interface 120 can be presented on a display for a computing device coupled to message composition logic 109, which can be—or can operate in association with—a web server (not shown). As such, message composition logic 109 can include libraries of style sheets and formats, as well as other sample electronic facsimile material, which can include data representing components of an electronic facsimile. These components (i.e., fax or facsimile components) can include facsimile data that represent electronic document 122 (e.g., as an attachment), a destination number (e.g. fax number), and a cover-page, among other things, any of which can be uploaded (or “pushed”) to messaging system 102 via an HTTP connection, for example, through packet network 110. In another example, interface 120 can be presented on a display for a client application, from which the facsimile data can be updated by a synchronization server or module (not shown). A synchronization server or module can be configured to synchronize copies of data records (e.g., between a client and messaging system 102). In still another example, interface 120 can be presented on a display for an email application in which a fax polling server or module (not shown) can poll and pull (e.g., periodically) the facsimile data. Or, the facsimile data can be delivered (e.g., using a protocol, such as SMTP) via a store-and-forward server or module (not shown) using a protocol, such as POP3.

In the example shown, messaging system 102 includes pre-processing logic and storage 150, a delivery manager 152 and prioritization logic 154. Pre-processing logic and storage 150 can store the fax components, fax transmission priority and the fax transmission schedule. Both pre-processing logic and storage 150 and delivery manager 152 can be configured to manage the delivery of electronic facsimiles the electronic facsimile can be delayed or otherwise lowered in priority. Further, delivery manager 152 can be configured to reduce congestion by delivering prioritized electronic facsimiles in accordance with their rankings, and by managing transmission resources so as not overburden any transmission resource while keeping each at an optimal rate of transmission (i.e., to reduce idle resources). Pre-processing logic and storage 150 is configured to preprocess any electronic facsimile component (e.g., cover sheet, messages, attached documents) by pre-rendering the electronic facsimile components into standard fax reception formats (e.g. such as a TIFF format). Fax component preprocessing can be scheduled to be performed during periods of time when other resources are idle (or are otherwise slow) and have the bandwidth to assist, for example, in pre-rendering the electronic facsimile components. Further, preprocessing can also facilitate a reduction in transmission resource processing delays, thereby freeing transmission resources to send more electronic facsimiles. Prioritization logic 154 can be configured to implement a variety of prioritization schemes (e.g., using weighted fax priorities) to reduce fax congestion in messaging system 102, which, in turn, can optimize transmissions of electronic messages. Prioritization logic 154 can use priorities of electronic messages, such as electronic facsimiles, to interleave fax deliveries based on, for example, the priority assigned to each electronic facsimile, a relative fax size, a quantity of fax transmissions to multiple destinations, and other like attributes. In one embodiment, prioritization logic 154 can be configured to communicate with transmission resources that “bid” for subsequent fax transmissions. Such transmission resources can notify delivery manager 152 (or an equivalent function) of its fax queue (not shown) and capacity, and can “bid” (or request) for the electronic facsimiles having relatively high priorities, should a bidding transmission resource have capacity (or is predicted to have capacity) to transmit an electronic facsimile. In one embodiment, a transmission controller 187 is configured to facilitate the delivery of electronic facsimiles subject to a bidding process. As shown, transmission controller 187 can be coupled to transmission resources (“TR2”) 181 and (“TR1”) 180 to determine the capacity of each of those transmission resources for delivery purposes. Transmission controller 187 can be configured to initiate discovery of available transmission resources, at least in one case. In one example, transmission controller 187 includes transmission queue 183 that stores a transmission priority/rank, for example, dependent upon capacity for each of transmission resources 181 and 180. Transmission controller 187 operates to weigh the transmission resource bids based on the transmission priority/ranks when determining which transmission resource will be used to deliver an electronic message.

Messaging system 102 includes a format converter 107, and message composition logic 109, any of which can be implemented in one or more servers and/or any number of software modules distributed in a system of one or more servers. Responsive to user input selections entered in relation to a portion 123 of interface 120, message composition logic 109 can be configured to—in whole or in part—perform one or more of the following actions in relation to electronic facsimiles: schedule delivery for a fax, assign a priority to a fax, and/or assign a preference (e.g., a sender might prefer that a recipient receive an electronic facsimile at one of devices 130, 132, 134, 136, and 138).

In at least one embodiment, format converter 107 can be configured to convert the format of electronic document 122 or the electronic facsimile components (either collectively or individually) into another format that is suitable for transmitting to a specific a communication device, regardless of whether the communicator device is compatible with T.30, T.38, or any other protocols or standards. In one embodiment, pre-processing logic and storage 150 can accept an unprocessed (i.e., not pre-rendered) electronic document 122 along path 155, as well as unprocessed electronic facsimile components (either collectively or individually) along the same path. In various embodiments pre-processing logic and storage 150 can accept a pre-processed (i.e., pre-rendered) electronic document 122 along path 191, or processed electronic facsimile components (either collectively or individually) along the same path.

In a specific embodiment, format converter 107 can format electronic document 122—as an attachment—or the electronic facsimile components into, for example, a device independent bitmap format for storage in pre-processing logic and storage 150 as a pre-rendered message (or pre-rendered portions thereof). Or format converter 107 can provide for immediate delivery (not shown) by dynamically rendering electronic document 122 or the electronic facsimile components into a device independent bitmap format, in real-time (or substantially in real-time), for sending as a dynamically-rendered message as electronic facsimile 105.

While FIG. 1A shows packet networks 110 and 142, and switched network 140, any communications network can be used. For example, private and/or public internet and switching networks can be used, such as IP networks (including protocols TCP, UDP, HTTP, etc.) and switched networks (including public switched telephone networks (“PSTN”) or the like, as well as cellular, short message service (“SMS”) and other wireless networks.) In one embodiment, interface 120 can be implemented as a hand-held device, such as a mobile phone 197.

As used herein, the term “electronic facsimile” refers generally, at least in one embodiment, to an electronic message that can be formed to include an electronic document, in compliance with specific protocols, such as those associated with ITU T.30 and T.38, or the like. An electronic facsimile can be formed by generating one or more associations among fax components so that they can be combined to produce an electronic facsimile. Examples of “fax components” include data representing content, such as that in an electronic document, a fax number and time and date stamp, a cover sheet, and the like. In some cases, the data representing a fax component can be affixed as part of the electronic facsimile (e.g., during dynamic rendering), whereas in other cases, the fax components can be separable from the electronic facsimile and combined prior to transmission, or after transmission. For example, an attached electronic document and a cover sheet—as separate fax components—can be pre-rendered either separately to form pre-rendered portions of an electronic facsimile, or in combination to form a single pre-rendered portion of the electronic facsimile. In some embodiments, a time and date stamp can be appended to the pre-rendered portion(s) of a pre-rendered message (i.e., a pre-processed message) is being transmitted as electronic facsimile 105. When affixed the fax data can be stored within a common data file as the electronic facsimile, such as a pre-rendered electronic facsimile, whereas separable fax data can be stored as separate files in one or more locations in messaging system 102. As used herein, in some instances, the term “fax data” can be used to describe a fax component. As used herein, the term “electronic document,” can refer, at least in one embodiment, to any data file (e.g., other than computer programs or system files) that are intended to be used in their electronic form, without necessarily being printed, whereby computer networks and electronic display technologies can help facilitate their use and distribution. In one embodiment, an electronic document 122 can be included in an electronic message, such as an electronic facsimile. As used herein, the term “panel,” at least in one embodiment, can refer to displays, palettes, tabs, windows, screens, portions of an interface, and the like. As used herein, the term “pre-rendered,” at least in one embodiment, refers to the formation and/or conversion of one or more fax component into a format compatible for transmission of electronic messages, including electronic facsimiles, via a telecommunication network. Examples of compatible formats include T.30 and T.38 compatible formats, such as TIFF and PDF. Other compatible formats can be used to transmit electronic facsimiles in accordance to various embodiments. As used herein, the term “dynamically rendered” refers generally, at least in one embodiment, to rendering one or more fax components in real-time (or nearly real-time) into a compatible fax format during the transmission and/or receipt of an electronic facsimile.

FIG. 1B is a diagram 160 of a messaging system configured to prioritize electronic messages, such as electronic facsimiles, and to deliver such messages based on a priority, according to at least one embodiment of the invention. Note that similarly-numbered elements in FIGS. 1A and 1B can share similar structures and/or functions, according to some embodiments. In this example, FIG. 1B shows messaging system 102 including prioritization logic 154 and a number of facsimile transceivers 163a to 163e, each of which can represent one or more transmission (and/or reception) sources in connection with devices 130, 132, 134, 136, and 138. As shown, facsimile transceivers 163a, 163b, 163c, 163d and 163e are configured to respectively facilitate communications via networks 199a to 199e with devices 130, 132, 134, 136, and 138 using, for example, specific communications standards and/or protocols. In a specific embodiment, facsimile transceivers 163a and 163b are configured to transmit and/or receive electronic facsimiles based on T.30, whereas facsimile transceivers 163c, 163d and 163e are configured to transmit and/or receive electronic facsimiles based on T.38. Other protocols are possible.

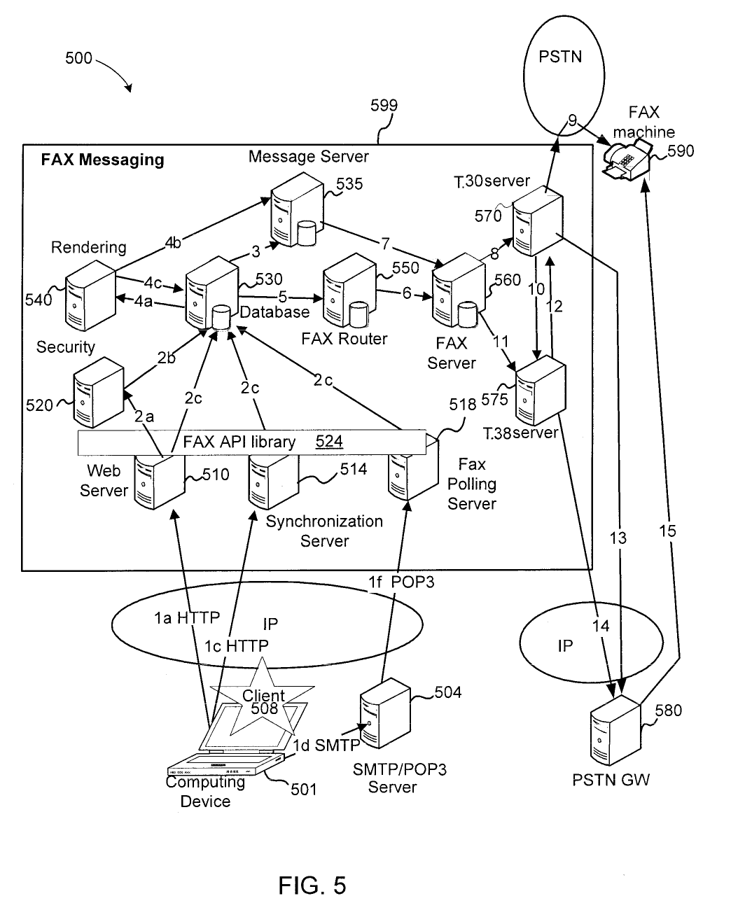

In this example, prioritization logic 154 includes a repository (“policy”) 155, a prioritization controller 157, and a prioritizer 156. Repository 155 is configured to store a number of sets of rules and policies that can be used to influence, among other things, how electronic facsimiles are prioritized, how resources within messaging system 102 are allocated, and which delivery process should be used for a specific endpoint (e.g., for a specific device 130a to 138). The rules and policies set forth repository 155 are not limited to governing these processes, but can be used to influence other functions of messaging system 102. Prioritization controller 157 can be configured to route electronic messages and facsimiles to devices 130a to 138, based on the priorities determined by prioritizer 156 as well as the capacities of facsimile transceivers 163a to 163d. In one embodiment, prioritization controller 157 can either monitor the transmission capacities of facsimile transceivers 163a to 163d or accept requests from facsimile transceivers 163a to 163d to service electronic facsimiles based on priority. Prioritizer 156 can be configured to determine priorities of electronic facsimiles, the priorities being set as a function of one or more of the following: sender inputs into messaging system 102, system-assigned priorities provided by messaging system 102, recipient inputs in relation to messaging system 102, and the like. In one embodiment, facsimile transceivers 163a to 163d can be implemented using servers 570 and 575 of FIG. 5.

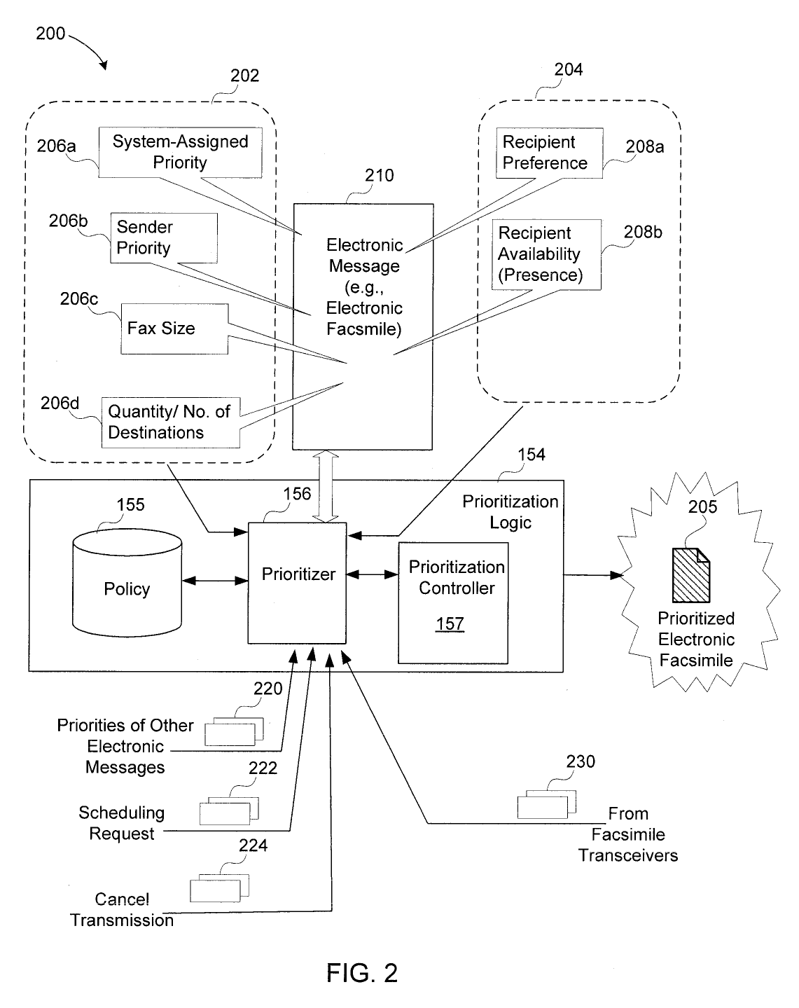

FIG. 2 is a diagram 200 showing an example of a process by which the prioritizer of FIG. 1B determines a priority for electronic facsimiles, according to at least one embodiment of the invention. Here, an electronic facsimile 210 can be associated with, and/or defined by, a number of attributes, such as a first set of attributes 202 and a second set of attributes 204. Examples of first set of attributes 202 are shown to include attributes that can be provided by the sender and messaging system 102 (FIGS. 1A and 1B). As shown, messaging system 102 can assign a system-assigned priority 206a to electronic message 210, associate a fax size 206c to electronic message 210, and determine a quantity of transmissions (or a number of recipients) 206d for electronic message 210. Examples of second set of attributes 204 are shown to include attributes that can be provided by the recipient. As shown, a recipient can optionally provide preferences 208a that can be associated with electronic message 210. In some instances, the availability 208b of the recipient can be linked to electronic message 210. Prioritizer 156 can examine the foregoing (or any other attribute) to determine the priority of electronic message 210.

Further, FIG. 2 shows that prioritizer 156 can also receive information 220 regarding the priorities of other electronic messages, information 222 regarding whether electronic message 210 has been scheduled for delayed delivery, information 224 as to whether the transmission of electronic message 210 should be canceled (e.g., due to a lack of funds in an account), and information 230 from facsimile transceivers to determine an optimal transmitting device. Prioritizer 156 can also be coupled to repository 155, which includes a number of policy rules. One set of rules can determine the delivery path for electronic message 210. For example, a set of delivery policies can be used to determine how to send an electronic facsimile via any of the following: a) Email the fax (e.g., to a unified messaging inbox or email application, b) Deliver via text messaging (e.g., SMS text or other wireless text), c) Deliver via Instant Message (e.g., text and content at a PC), d) Deliver via a T.38 server (as a transmission source/facsimile transceiver) to an Internet PSTN Gateway (not shown), e) Deliver via switched T.30 server (as a transmission source/facsimile transceiver) to a PSTN-capable endpoint, f) Schedule for later attempted delivery (e.g., based on information 222), g) Allow another fax transmission to proceed before this transmission (e.g., based on information 220), and g) Cancel fax transmission (e.g., based on information 224). In New of the foregoing, prioritizer 156 can determine the priority of electronic message 210 to generate prioritized electronic facsimile 205.

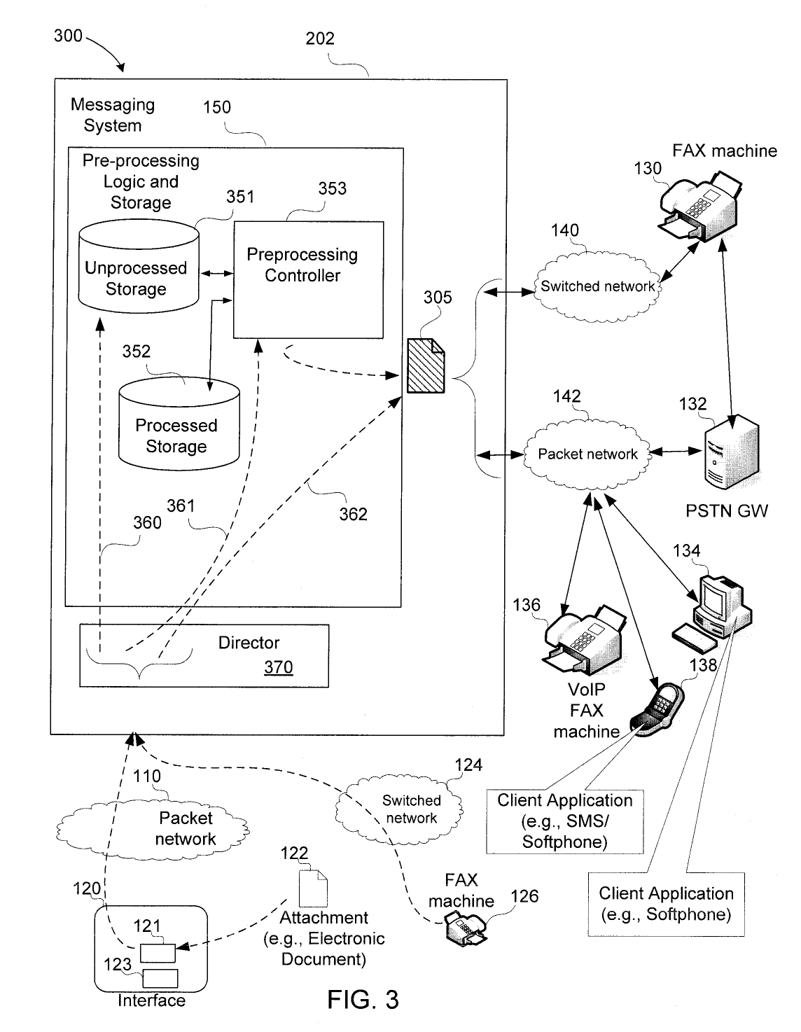

FIG. 3 is a diagram 300 of a messaging system including pre-processing logic for facilitating delivery of electronic messages, such as electronic facsimiles, according to at least one embodiment of the invention. Note that similarly-numbered elements in FIGS. 1A, 1B and 3 can share similar structures and/or functions, according to some embodiments. In this example, FIG. 3 shows messaging system 202 including pre-processing logic 150 and a director 370 configured to direct electronic messages that are to be dynamically-rendered and transmitted via path 362 from electronic messages that are to be pre-rendered and stored via paths 360 and 361 prior to transmission as electronic facsimile 305.

Pre-processing logic 150 is shown to include a repository 351 for storing unprocessed (i.e., not pre-rendered) fax components (collectively or individually) that are received via path 360, and a repository 352 for storing processed fax components that are received via path 361 and are pre-processed (i.e., pre-rendered) by pre-processing controller 353. Or, repository 352 can store pre-processed fax components that were fetched from repository 351 before pre-processing controller 353 processed them. In at least one embodiment, pre-processing logic 150 can be configured to access repository 351 for processing the unprocessed (i.e., not pre-rendered) fax components as a function of resource availability (e.g., when message system 202 has excessive bandwidth during which to apply computational resources to pre-rendering operations). In various embodiments, preprocessing controller 353 can be configured to format electronic facsimile components (either collectively or individually) into a format that is suitable for transmitting to a specific communication device, regardless of whether the communication device is compatible with T.30, T.38, or any other protocols or standards.

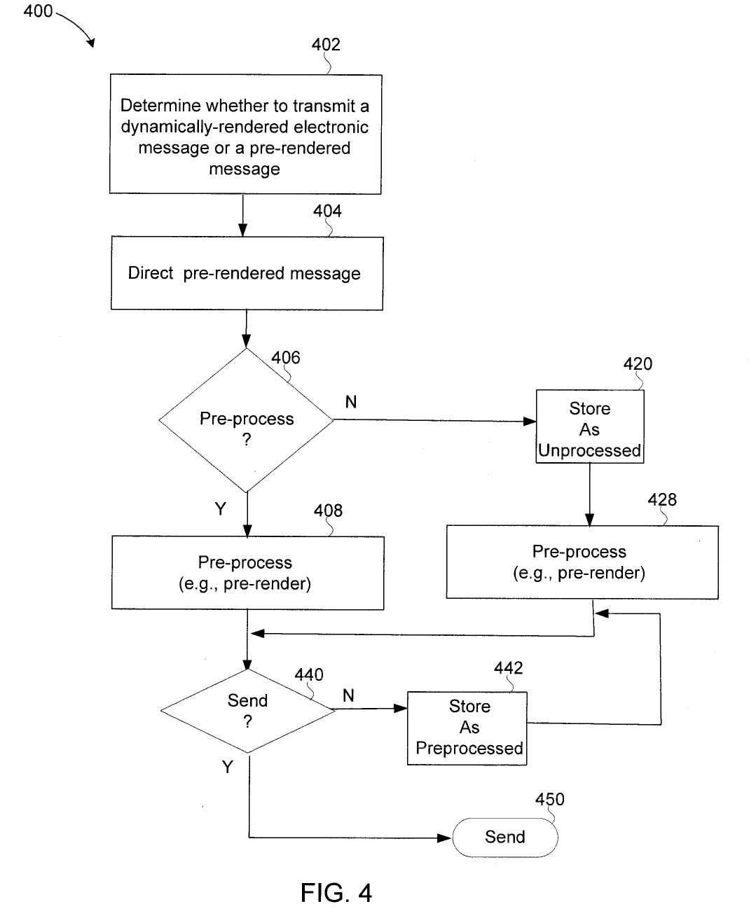

FIG. 4 is a flow diagram showing an example of a method for pre-processing electronic facsimiles, according to one embodiment of the invention. Flow 400 begins at 402. A determination is made at 402 to either transmit a dynamically-rendered electronic message or a pre-rendered message. Consider that at 404, an electronic message is directed to a process that will pre-render the electronic messages (or portions thereof). Next, at 406, a determination is made as to whether pre-processing should be performed before storage. If yes, then flow 400 continues to 408 at which one or more electronic facsimile components can be pre-rendered. But if no, then flow 400 continues to 420 at which the unprocessed components are stored, after which the unprocessed components are pre-rendered at 428. Flow 400 continues to 440, at which a determination is made to either send an electronic facsimile or not. If an electronic facsimile is not to be sent, then flow 400 continues to 442 at which the fax components are stored (or remain stored). But if an electronic facsimile is to be sent, then flow 400 continues to 450 at which the electronic facsimile is sent, thereby terminating flow 400.

FIG. 5 is a diagram showing an example of a messaging system, according to at least one embodiment of the invention. Here, messaging system 599 includes a web server 510, a synchronization server 514, and a fax polling server 518, each of which can individually or collectively implement or access a Fax API library 524. Messaging system 599 further includes a security server 520, which is optional, a rendering server 540, a database 530, a message server 535, a fax router 550, a fax server 560, a T.30 server 570, and a T.38 server 575. As shown, messaging system 599 can be coupled via a network (e.g., an IP network) to a computing device 501 configured to operate as a client 508 to form web-based electronic facsimiles. Computing device 501 can include a softphone application or another client application program to generate electronic facsimiles, and/or an email application to form email-based electronic facsimiles. Messaging system 599 can use an SMTP/POP3 server 504 to facilitate the provisioning of email-based electronic facsimiles. Further, messaging system 599 is shown coupled via a PSTN network 9 to a fax machine 590, as well as via, for example, an IP network to a PSTN gateway (“GW”) 580.

In operation, facsimile transmission requests arrive from any of a multiple interfaces to one of three functional servers: Web (510), Synchronization (514) and Fax Polling (518) servers, according to one embodiment. Note that the capabilities of these three servers can be hosted in an enterprise or a datacenter. These servers can be configured to upload requests for electronic facsimiles to the hosted Database (530) via a database or any other interface (2c). As an implementation example, the Web (510), Synchronization (514) and Fax Polling (518) servers can include an application library API 514. Each of Web (510). Synchronization (514) and Fax Polling (518) servers can be configured to invoke the library 524 in relation to an API. For example, the API can be configured to invoke a client interface to transmit a fax record to the Database (530).

Database (530) server can operate to invoke stored procedures to record the fax records in a Database schema compatible with Database (530), or can send the fax material to either a Rendering server (540) or to a Message server (535), or both. The Database (530) can reference the corresponding fax content files in Message Server (535) via a URL or a mounted drive (3), such as e:\fax_folder\1934567890.fax. Thus, a fax policy record can be stored in a Database server (530) schema, and this fax policy record can specify the fax content file on a Message server (535). Then, rendering server (540) can pre-format the fax content and update (4b) the content on the Message server (535) or on the Database server (530). A fax content file can include data representing either an electronic document or an electronic facsimile, or both, or any portions thereof. In instances when a fax file (e.g., an electronic facsimile) is not pre-formatted (e.g., not pre-rendered) then a Fax Router (550) or a Fax server (560) can format (e.g., dynamically render) the electronic facsimile while transferring (6, 7) or while transmitting (8, 11) the tax.

At a scheduled or at a first available time, the Database server (530) can request that Fax Router (550) select a preferred fax delivery route and corresponding fax delivery resources, such as a Fax server (560). Using a protocol, the Fax Router (550) sends a multicast or a broadcast request (6) to a network and selects the first responding Fax Router (550) resource to reply to the request. The Fax Router (550) can forward the fax content to the Fax server (560) or can send the Fax server (560) pointers to stored fax material (e.g. electronic facsimile). The Fax server (560) can request or can pull the fax material from a Database (530) or from a Message server (535) to access the fax delivery route, priority and the fax document material.

The Fax server (560) then can initiate a call to a switching service (such as the telephone line T.30 server 570 via 8) or to a network service (such as the Internet T.38 server 570 via 11). In one embodiment, the T.38 server (570) requests (12) a telephone line T.30 server (570) to initiate a telephone call while the T.38 server (570) negotiates a fax transfer rate and sends the fax material.

The Fax user interface can be displayed on the Subscriber's computing device (501) using a web server (510), or a computing device including client application (508). The fax number, and any cover-page data and electronic documents to be faxed can be composed on the computing device (501), on the web server (510), or can be selected from libraries of style sheets (e.g., data describing how to format the presentation of text and grannies) and other sample fax material.

When composed, the fax material (e.g., electronic facsimile) can be uploaded (pushed) to FAX Messaging system 599 via HTTP (1a). Or, the data representing or association with an electronic facsimile can be updated by a synchronization server (514). In one embodiment, synchronization server (514) is a differential synchronization server, which can be configured to perform differential synchronization techniques to keep two or more copies of the same electronic message, including an electronic facsimile, synchronized with each other in real-time (or substantially in real-time). As such, differential synchronization server (514) can be configured to check against a record residing at client 508 for any revised content relating to a record (not shown) for the same electronic message (or electronic facsimile) stored in message system 599, such as in, for example, database 530. In one instance, data for an electronic facsimile can be periodically polled and pulled by a Fax Polling server (518), or can be delivered (using a common protocol SMTP 1d) via a store-and-forward server SMTP or POP3 server 504) using a specialized protocol (POP3 1f).

In various embodiments, any of servers (510, 514, and 518) can send the fax data to the Database (530). Fax delivery information can be stored in the Database (530) and any fax document can be stored in a Message Server (535). Otherwise the fax data and delivery information can be stored in a Message Server (535) or in a Fax Router (550).

Data representing fax content can include a cover-page, content pages and/or attached documents, such as an electronic document. Attached electronic documents can be in any type of recognized formats. Attached documents can be pre-rendered into common fax format by a Rendering server (540) which places the documents in, for example, a device independent bitmap format and stores the documents in Database (530), or in an external Message server (535). Otherwise, the documents can be dynamically rendered when transmitting from a Fax server (560), a switched network server (for example a T.30 server 570), or at a network packet server (for example a T.38 server 575).

Fax attachments can be converted by the Rendering server (540) from any of several document formats into a specific format. Otherwise Fax attachments can be converted while sending by the Fax Router (550) or the Fax server (560) into a fax format. When sending a fax via a direct connection via the internet, the Client application (508) can deliver a pre-rendered file via an HTTP client POST to the Synchronization server (514) listening for data via its HTTP server. In one embodiment, client application 508 includes executable instructions to enable a client computing device to interact with a messaging system, according to the various embodiments of the invention. In one embodiment, client application 508 is a softphone.

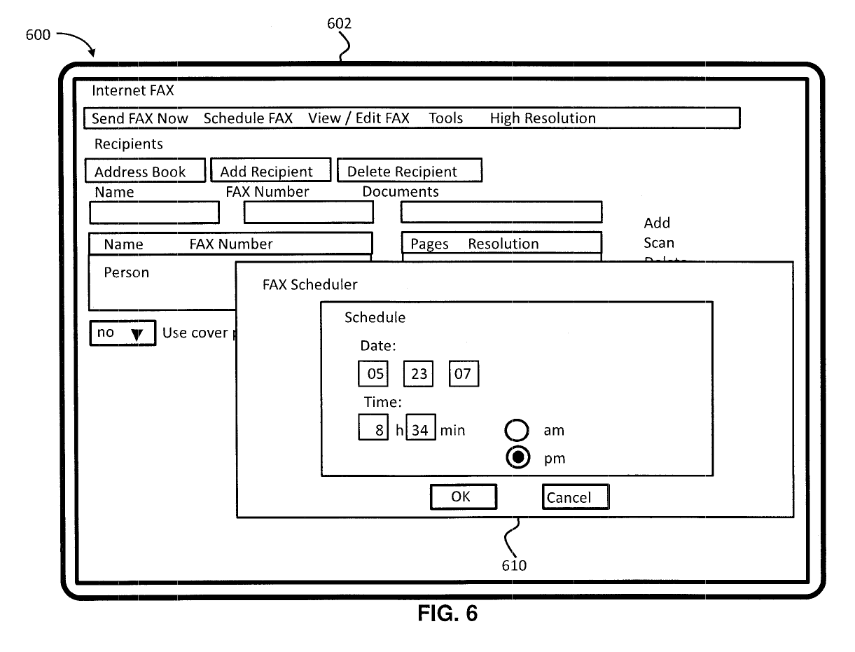

The Client application (508) and Web server (510) client interfaces can set future delivery dates and times (FIG. 6). For example, the Database server (530) can request Fax Router (550) to select preferred fax delivery routes and corresponding fax delivery resources; such as a Fax server (560). As such, Messaging System 599 can use various methods to select a delivery Fax Router (550) or Fax server (560). For instance, Fax Router (550) can send a multicast or a broadcast request (6) to a network and can then select the first responding Fax Router (550) resource to reply to the request. This protocol shifts the selection of the fax transmitter from the Fax Router (550) to available network resources. Those network resources can bid to receive transmissions using customized locally weighted and computed bidding algorithms.

The Database server (530) can forward the fax content to the Fax server (560) or can send the Fax server (560) pointers to stored fax material. The Fax server (560) can request or can pull the fax material from a Database (530) or from a Message server (535) to access the fax delivery route, priority and the fax document material. If the fax file is not pre-formatted, then a Fax Router (550) or a Fax server (560) can format the fax content while transferring (6, 7) or while transmitting (8, 11) the fax, according to an embodiment.

Both the Database server (530) and the Fax Router (550) can adjust fax transmission times according to assigned priorities and from monitoring the fax transmission interface (9, 14) congestion. For example, to process low priority or short faxes, the Database server (530) or the Fax Router (550) may transmit a single fax between hither priority or long faxes (such as faxes with attached documents) or between multiple transmission of the same lax to different receiving endpoints.

the Fax server (560) can invoke an interface (8) to initiate a call to a traditional T.30 server (570) switching service or via an interface (11) to an Internet T.38 server (575) network service. In one embodiment, the T.38 server (570) requests (12) a telephone line from the 1.30 server (570) which dials the telephone line while the T.38 server (575) negotiates the fax transfer rate and sends the fax material. A fax receiving endpoint can be a traditional analog (PSTN) telephone, an IP (VoIP) fax, a unified messaging email box or some other fax receiver.

In one embodiment, any of Database (530) or Message Server (535) or lax Router (550) can be configured to deliver an electronic facsimile at a user-scheduled time. A scheduled fax delivery can have multiple destinations. In some cases, any of Database (530) or Message Server (535) or Fax Router (550) can check various Instant Message servers (such as MSN, AIM, Yahoo) for receiver status. From the presence result (e.g., determining a receiver/recipient is present and available) and one or more sender preferences, Database (530) or Message Server (535) or Fax Router (550) can be configured to select any of the following delivery policies to send the fax via: a) Email the fax, b) Deliver via text messaging, c) Deliver via Instant Message, d) Deliver via a T.38 server (575) to an Internet (14) PSTN Gateway (580), e) Deliver via switched T.30 server (570) to the PSTN (9), f) Schedule for later attempted delivery, g) Allow another fax transmission to proceed before this transmission, and/or g) Cancel fax transmission.

For policies a), b) and c) the fax content can arrive at a corresponding user interface, respectively a) unified messaging inbox or standard email, b) SMS text or other wireless text and c) text and content at a PC. For policy d) the fax content can arrive at a unified messaging inbox or a Fax machine (590). For policy e) the fax content can arrives at a PSTN gateway (580) where it can be distributed to a unified messaging inbox or a Fax machine (590).

Messaging system 599 can leverage popular email services to send faxes, according to one embodiment. A fax delivered as email can include a cover page, content pages and (optionally pre-processed) document files. An end-user can send a fax message addressed to one or more known email addresses for delivery to multiple fax recipients. Recipient addressing can be embedded within client softphone or within an email; equivalent to addressing email to multiple recipients. The email subject line can be used for the fax cover page. Email attachments become documents to be uploaded and converted to fax formats.

A single fax can be scheduled for consecutive transmission (or parallel transmissions) to several destinations. After sending a first fax copy, system 599 can review other pending transmission requests and can transmit another fax before the next scheduled transmission, thus “interleaving” faxes based on, for example, a priority. Interleaving fax transmissions implements a “fairness” policy to provide some transmission time to each fax; such as send a single or a small fax before a large fax or before sending one fax to multiple destinations.

Using one protocol, Fax Router (550) can be configured to send a multicast or a broadcast request (6) to a network, and can select the first responding Fax Router (550) resource to reply to the request. Fax Router (550) can forward the fax content to the Fax server (560) or can send Fax server (560) pointers to stored fax material. Fax server (560) can request or can pull the fax material from a Database (530) or from a Message server (535) to access the fax delivery route, priority and the fax document material.

Fax server (560) then can initiate a call to a traditional switching service (such as the telephone line T.30 server 570 via 8) or to a network service (such as the Internet T.38 server 570 via 11). In one embodiment, the T.38 server (570) requests (12) a telephone line T.30 server (570) to initiate a telephone line while the T.38 server (575) negotiate the fax transfer rate and sends the fax material.

FIG. 6 is a diagram 600 showing an example of a panel configured to schedule delivery an electronic message via a messaging system, according to at least one embodiment of the invention. Here, a panel 610 in an interface 602 can be configured to transmit an electronic facsimile at any time and at any date.

In at least some of the embodiments of the invention, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

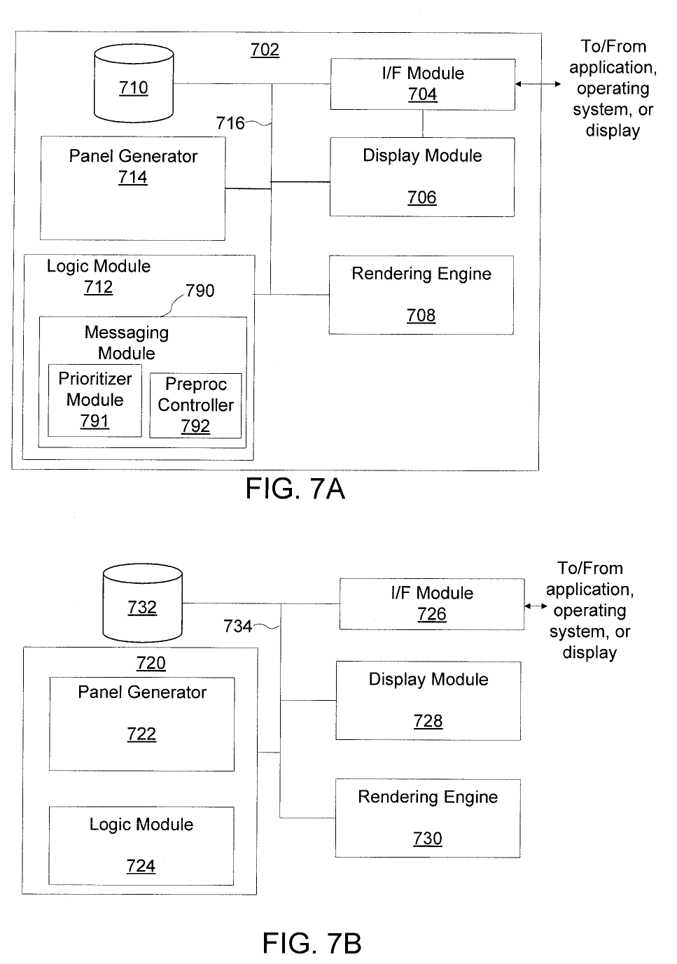

FIG. 7A illustrates an example of a panel presentation application for electronic message prioritization and delivery, according to various embodiments of the invention. In at least one embodiment, an interface to provide for prioritizing electronic facsimiles can be implemented in a panel, such as a single panel, in one or more portions thereof, or in separate panels. Application 702 can be a softphone application (e.g., an application configured to adapt a computing device to perform known telephony functions), or an application disposed on a server, such as web server 510 (FIG. 5), to carry out the active call processing and/or notification generation functionalities described herein. Here, application 702 includes interface (“I/F”) module 704, display module 706, rendering engine 708, repository 710, logic module 712, panel generator 714, and data bus 716. In some examples, the number and type of elements shown and described may be varied and are not limited to the descriptions provided. In some examples, the above-described elements can be implemented as part, component, or module of application 702. As an example, application 702 can be implemented to include either commands for establishing rules to effect electronic message prioritization and delivery, as well as effecting communication among endpoints, the commands imparting functionalities as described herein. Logic module 712 can be implemented as software, hardware, circuitry, or a combination thereof to implement control logic for the described techniques for panel presentation. As used herein, the term “panel,” at least in one embodiment, can refer to displays, palettes, tabs, windows, screens, portions of an interface, and the like.

In some examples, logic module 712 can be configured to control panel generator 714 to form a call management system configured to present electronic message prioritization and delivery options to, for example, provide for customizable delivery of electronic facsimiles. Rendering engine 708 can be configured to operate as a layout engine for web pages, for example, to manipulate both content (e.g., as expressed in or including HTML, XML, image files, etc.) and formatting information (e.g., as expressed in or including CSS, XSL, etc.) for rendering the data or information as one or more panels on interface 706 (FIG. 7). Interface module 704 can exchange panel presentation data, including content data, image data, audio data, as well as other data, between application 702 and another application (e.g., a host, client, web services-based, distributed (i.e., enterprise), application programming interface (“API”), operating System, program, procedure or others) that can use data and information generated from panel Generator 714 to render presented panels on a display screen. In other examples, the above-described techniques and elements can be varied in design, implementation, and function and are not limited to the descriptions provided. In one embodiment, logic module 712 can include messaging module 790 that is configured to include structure and/or functionality similar to one or more previously-described communication messaging systems and/or components thereof. For example, logic module 712 can also include prioritization logic (“PL) module 791 and a preprocessing controller (“Preproc Controller”) module 792, both of which can be configured to be accessed via an interface. For example, prioritization logic module 791 can be configured to control aspects of delivery of electronic facsimiles based on, for example, priorities, and preprocessing controller module 792 can be configured to preprocess electronic facsimiles.

FIG. 7B illustrates an alternative example of a panel presentation application for implementing an interface to provide for electronic message prioritization and delivery, according to one embodiment of the invention. Here, application 720 includes panel generator 722 and logic module 724, which can have equivalent functionality as 712 of FIG. 7A. Further, application 720 is shown in data communication with interface (“I/F”) module 726, display module 728, rendering engine 730, and repository 732. Data bus 734 can be configured to send or receive data among application 720, I/F module 726, display module 728, rendering engine 730, and repository 732. In other examples, more, fewer or different elements can be used and implemented without limitation to the examples provided above.

In some examples, logic module 724 and panel generator 722 can be implemented as part of application 720, which can be implemented separately from other functional components or modules, such as interface module 726, display module 728, rendering module 730, and repository 732. Data bus 734 can be implemented to communicate data over a given port between application 720 and interface module 726, display module 728, rendering module 730, and repository 732. In some instances, application 720 can be implemented as a standalone application or as a component (i.e., module) of another application. Data or information (e.g., content or file data including priority rules and the like) associated with a panel can be stored in repository 732, which can be implemented using a database, data store, data warehouse, or any other type of data repository or structure. In other examples, more, fewer, or different modules can be used to implement the described techniques for panel presentation and are not limited to those provided.

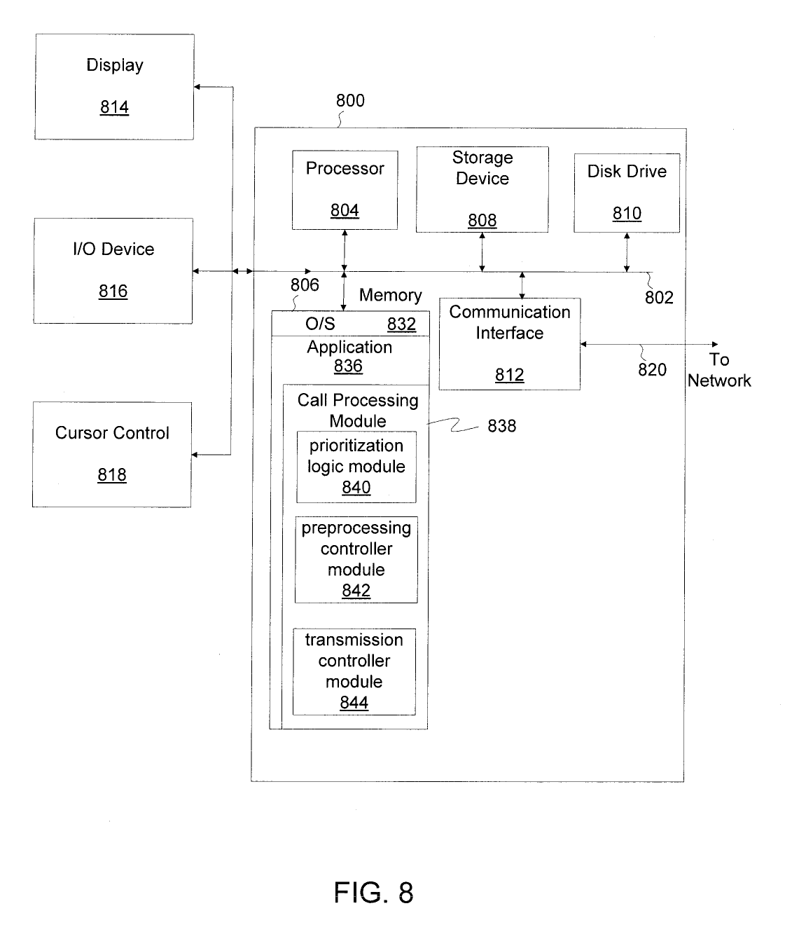

FIG. 8 illustrates an exemplary computer system suitable for electronic message prioritization and delivery, according to at least one embodiment of the invention. In some examples, computer system 800 can be used to implement computer programs, applications, methods, processes, or other software to perform the above-described techniques and to realize the structures described herein. Computer system 800 includes a bus 802 or other communication mechanism for communicating information, which interconnects subsystems and devices, such as one or more processors 804, system memory (“memory”) 806, storage device 808 (e.g., ROM), disk drive 810 (e.g., magnetic or optical), communication interface 812 (e.g., a modem, Ethernet card, or any other interface configured to exchange data with a communications network), display 814 (e.g., CRT or LCD), input device 816 (e.g., keyboard), and pointer cursor control 818 (e.g., mouse or trackball). In one embodiment, pointer cursor control 818 invokes one or more specialized commands that can facilitate scheduling of electronic facsimiles, as well as prioritizing delivery of electronic facsimiles. Pointer cursor control 818 can interact via a pointer cursor with interfaces for a call processing system to process active calls and generate notifications.

According to some examples, computer system 800 performs specific operations in which processor 804 executes one or more sequences of one or more instructions stored in system memory 806. Such instructions can be read into system memory 806 from another computer readable medium, such as static storage device 808 or disk drive 810. In some examples, hard-wired circuitry can be used in place of or in combination with software instructions for implementation. In the example shown, system memory 806 includes modules of executable instructions for implementing an operation system (“O/S”) 832, an application 836, and a messaging module 838, which, in turn, can implement a prioritization logic module 840, a preprocessing controller module 842, and a transmission controller module 844 to provide the functionalities described herein.

The terms “computer readable medium” and “computer readable media” refer, at least in one embodiment, to any medium that participates in providing instructions to processor 804 for execution. Such a medium or media can take many forms, including but not limited to, non-volatile media, volatile media, and transmission media. Non-volatile media includes, for example, optical or magnetic disks, such as disk drive 810. Volatile media includes dynamic memory, such as system memory 806. Transmission media includes coaxial cables, copper wire, and fiber optics, including wires that comprise bus 802. Transmission media can also take the form of electromagnetic, acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples, execution of the sequences of instructions can be performed by a single computer system 800. According to some examples, two or more computer systems 800 coupled by communication link 820 (e.g., links to LAN, PSTN, or wireless network) can perform the sequence of instructions in coordination with one another. Computer system 800 can transmit and receive messages, data, and instructions, including program code (i.e., application code) through communication link 820 and communication interface 812. Received program code can be executed by processor 804 as it is received, and/or stored in disk drive 810, or other non-volatile storage for later a hand-held device, such as a mobile phone, with more or fewer modules shown in system memory 806. But in other embodiments, system 800 can be implemented as a personal computer (i.e., a desk top computer) or any other computing device.

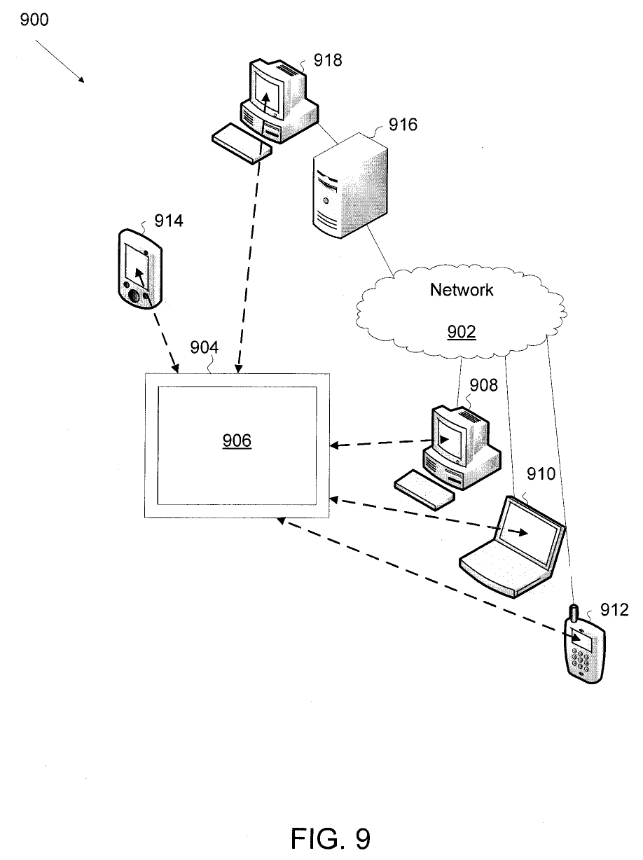

FIG. 9 illustrates an example of an interface for facilitating electronic message prioritization and delivery, according to various embodiment of the invention. Here, system 900 includes network 902, display environment 904, interface 906, which can be presented on devices such as computer 908, notebook computer (“notebook” or “laptop”) 910, smart phone 912, personal digital assistant (“PDA”) 914, server 916, and administrator computer 918. In other examples, the number and type of devices can be varied and are not limited to those shown and described.

In some examples, one or more panels for prioritized and/or schedules electronic facsimile delivery and/or call communication (e.g., using interface 906 for connecting calls, sending electronic messages, etc.) can be presented on interface 906, which can be an interface for an application, such as a video and audio editing application, or as a web browsing program, Internet content portal, client or desktop application for any purpose. Panels can be used to provide additional or supplemental information that can be contextually relevant to another panel presented in interface 906. Computer 908, notebook computer (“notebook” or “laptop”) 910, smart phone 912, personal digital assistant (“PDA”) 914, server 916, and administrator computer 918 can provide content data for rendering content as well as other data, which can be implemented to generate, for example, user inputs configured to accept data to deliver prioritized and/or scheduled electronic facsimile call routing and to answer and make phone calls. In some cases, an operating system installed on computer 908 can communicate (i.e., via an application programming interface (“API”)) content data and/or other related data to another application installed on computer 908 to render (i.e., interpreting data and information to draw or display the content in an interface) one or more panels presented in interface 906. In some examples, different types of panels can be rendered in interface 906. In one embodiment, interface 906 can include any number and/or any type of display environments, such as CRT and LCD displays. Note that the above-described system and elements can be varied and are not limited to the descriptions or examples provided.

In at least some of the embodiments of the invention, the structures and/or functions of any of the above-described interfaces and panels can be implemented in software, hardware, firmware, circuitry, or a combination thereof. Note that the structures and constituent elements shown in FIGS. 7A to 9, as well as their functionality, can be aggregated with one or more other structures or elements. Alternatively, the elements and their functionality can be subdivided into constituent sub-elements, if any. As software, the above-described described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML. XHTML, HTTP, XMPP, and others. These can be varied and are not limited to the examples or descriptions provided.

Thus, the foregoing descriptions of specific embodiments of the invention are presented for purposes of illustration and description. They are not intended to be exhaustive or to limit the invention to the precise forms disclosed; many alternatives, modifications, equivalents, and variations are possible in view of the above teachings. For the purpose of clarity, technical material that is known in the technical fields related to the embodiments has not been described in detail to avoid unnecessarily obscuring the description. Thus, the various embodiments can be modified within the scope and equivalents of the appended claims. Further, the embodiments were chosen and described in order to best explain the principles of the invention and its practical applications: they thereby enable others skilled in the art to best utilize the invention and various embodiments with various modifications as are suited to the particular use contemplated. Notably, not every benefit described herein need be realized by each embodiment of the present invention; rather any specific embodiment can provide one or more of the advantages discussed above. In the claims, elements and/or operations do not imply any particular order of operation, unless explicitly stated in the claims. It is intended that the following claims and equivalents define the so of the invention.

What is claimed:

1. A system configured to deliver electronic messages, the system comprising:
a messaging system configured to
receive a user input from an interface, the user input comprising at least one electronic facsimile component and a transmission schedule for an electronic facsimile, the electronic facsimile comprising the at least one electronic facsimile component, the messaging system further comprising:
a message composition logic configured, responsive to the user input, to:
schedule transmission for the electronic facsimile,
assign a priority ranking to the electronic facsimile, and
assign a delivery preference to the electronic facsimile;
a pre-processing logic and repository configured to:
pre-render the at least one electronic facsimile component into a fax format,
store at least one transmission priority and the facsimile transmission schedule, and
store the pre-rendered electronic facsimile component;
a prioritization logic configured to implement a prioritization scheme; and
a delivery manager operatively connected with the pre-processing logic and repository and with prioritization logic, the delivery manager configured to transmit a plurality of prioritized electronic facsimiles in accordance with the priority ranking.

2. The system as in claim 1 wherein the messaging system further comprises:
a format converter operatively connected with the message composition logic and with the preprocessing logic and repository, the format converter configured to pre-render at least one electronic facsimile component into a format transmissible as an electronic facsimile before the at least one electronic facsimile component is stored in the pre-processing logic and repository.

3. The systems as in claim 1 wherein the delivery manager is configured further to:
determine a priority associated with the electronic facsimile; and
delay transmission of the electronic facsimile based on the priority.

4. The system as in claim 1 wherein the first communications network is one of a packet network and a switched network, and wherein the second communications network is the other of the packet network and the switched network.

5. The system as in claim 1 wherein the prioritization logic is configured further to:
apply the prioritization ranking to make a prioritization scheme, the prioritization scheme to interleave transmission of a plurality of electronic facsimiles based on at least one of a relative size of each of the plurality of electronic facsimiles, and a quantity of transmissions of the plurality of electronic facsimiles to a plurality of destinations.

6. The system as in claim 1 wherein
the prioritization logic is configured to communicate with a plurality of transmission resources; and
the transmission resources are configured to bid to transmit the electronic facsimiles in the order of a highest relative priority to a lowest relative priority, depending on availability based on one of a lack of an electronic facsimile queue of each transmission resource, and an availability based on an existing queue.

7. The system as in claim 6 further comprising:
a transmission controller configured to interact with the plurality of transmission resources to discover an availability of each the transmission resource based on the priority ranking of the electronic facsimile.

8. The system as in claim 7 wherein the transmission controller further comprises:
a transmission queue configured to store a transmission rank for each of the transmission resources, wherein the transmission controller is configured further to weigh the transmission resource bids based on the transmission rank to determine which transmission resource to use to transmit the electronic facsimile.

9. The system as in claim 1 wherein the prioritization logic further comprises:
a prioritization repository configured to store at least one set of rules and policies to set the priority ranking for the electronic facsimile;
a prioritization controller configured to determine the priority ranking for transmission of the electronic facsimile; and
a prioritizer configured to route the electronic facsimile to a destination based on at least one of the priority ranking determined by the prioritizer and a relative capacity of each of a plurality of transmission resources.

10. Computer readable media comprising executable instructions to:
determine priorities of electronic facsimiles;
store the electronic facsimiles as pre-processed electronic facsimiles or unprocessed electronic facsimiles based on a first subset of the priorities;
queue a first subset of the electronic facsimiles for transmission at a plurality of transmission resources to form queued electronic facsimiles as function of the priorities; and
transmit the queued electronic facsimiles over either a switched network or a packet network.

11. The computer readable media of claim 10 further comprising executable instructions to:
monitor capacities of the plurality of the transmission resources to transmit the queues electronic facsimiles; and
queue a second subset of the electronic facsimiles as a function of the capacities.

12. The computer readable media of claim 10 further comprising executable instructions to:
monitor resource availability of a messaging system to pre-render the unprocessed electronic facsimiles;
determine that a resource of the messaging system is available to pre-render an unprocessed electronic facsimile; and
preprocess the unprocessed electronic facsimile to form a preprocessed electronic facsimile.

13. The computer readable media of claim 10 wherein the executable instructions to queue the first subset of the electronic facsimiles further comprise executable instructions to:
queue the first subset of the electronic facsimiles based on a plurality of transmission attributes.

14. The computer readable media of claim 13 wherein the executable instructions to queue the first subset of the electronic facsimiles based on the plurality of the transmission attributes further comprise executable instructions to:
queue an electronic facsimile based on one or more of a system-assigned priority, a sender priority, a fax size, a quantity of electronic facsimiles associated with a sending interface, and a number of destinations.

15. The computer readable media of claim 13 wherein the executable instructions to queue the first subset of the electronic facsimiles based on the plurality of the transmission attributes further comprise executable instructions to:
queue an electronic facsimile based on one or more of a recipient preference and a recipient availability.

16. A method for supporting transmission of an electronic facsimile, the method comprising:
receiving with a prioritization controller of a messaging system at least one attribute of the electronic facsimile, the attribute provided by at least one of a sender of the electronic facsimile, the messaging system, and an intended recipient of the electronic facsimile;
setting with a prioritizer of the messaging system a transmission priority for the electronic facsimile as a function of the at least one attribute of the electronic facsimile;
implementing the transmission priority, wherein the transmission priority facilitates reduction of or reduces congestion of a plurality of messaging resources; and
transmitting the electronic facsimile according to the transmission priority.

17. The method as in claim 16 wherein receiving the at least one attribute further comprises:
receiving the at least one attribute as one or more of:
at least one priority of at least one other electronic message;
a delayed scheduled delivery for the electronic facsimile;
a cancellation for transmission of the electronic message;
an optimal outbound device for the electronic facsimile from a plurality of facsimile transceivers;
a system-assigned priority assigned by the messaging system;
a size associated with the electronic facsimile by the messaging system;
a quantity of transmissions for the electronic facsimile determined by the messaging system;
a priority input by the sender;
at least one preference supplied by the intended recipient of the electronic facsimile; and
an availability of the intended recipient;
and
adjusting with the priority controller the transmission priority of the electronic facsimile according to the information received through the receiving step.

18. The method as in claim 17 further comprising:
applying at least one policy stored in a repository operatively coupled with the prioritization controller, wherein applying the at least one policy determines the delivery path of the electronic facsimile.

19. The method as in claim 17 further comprising:
pre-processing the electronic facsimile when a delivery time can be delayed or otherwise transmitted with a lesser priority.

20. The method as in claim 19 wherein pre-processing the electronic facsimile further comprises:
pre-rendering a plurality of electronic facsimile components into a standard fax reception format to create a pre-rendered electronic facsimile.

21. The method as in claim 20 where the pre-rendering step is followed by storing the pre-rendered electronic facsimile in a repository before the transmitting step.

22. The method as in claim 17 further comprising:
interleaving delivery of a plurality of electronic facsimile based on the at least one attribute.

23. The method as in claim 16 further comprising:
bidding by a plurality of transmission resources to a delivery manager function of the messaging system for transmitting the electronic facsimile.
